(19) United States
(12) Patent Application Publication
(10) Pub. No.: US 2025/0187895 A1
(43) Pub. Date: Jun. 12, 2025

(54) DEVICE AND METHOD FOR ASEPTIC FILLING OF PACKAGES

(71) Applicant: Ján SOFRANKO, Siroke (SK)

(72) Inventor: Ján SOFRANKO, Siroke (SK)

(21) Appl. No.: 18/843,476

(22) PCT Filed: Mar. 16, 2022
(86) PCT No.: PCT/IB2022/052351

§ 371 Date: Sep. 3, 2024

(30) Foreign Application Priority Data
Mar. 2, 2022 (SK) PP 25-2022

(51) Int. Cl. B67C 7/00; B67C 3/10; B67C 3/26

(52) U.S. Cl. CPC B67C 7/0073; B67C 3/10; B67C 2003/2697

(57) ABSTRACT

A device for aseptic filling of packages includes an aseptic chamber (1), a filling arm (3), a sealing head (7), a closure carrier (2), a package carrier (4), a package sterilization station (6), a sterile antechambers (8), power element cabinets (9), power elements housed therein, a closure cover (10), a filling arm shaft (35), a sealing head shaft (42), and a closure carrier shaft (43).

### FIELD OF TECHNOLOGY

The invention relates to a method of aseptic filling and sealing of packages in a pressurized space.

### PRIOR ART

At present, the equipment is used in the aseptic filling of products into packages and their sealing, which performs the individual processes in sterilization, activation, filling and sealing of packages in separate positions, to which the package must be moved within the space; but this space is very difficult and complicatedly to maintain in absolutely cleanness, as the entry and exit of packages from the non-sterile to the sterile environment in the equipment creates an air vortex, which can lead to secondary contamination of the filled product. Due to their size, these devices require hundreds to thousands of liters of sterile space and sterilization not only of the internal, but also the external parts of the package.

### The Essence of the Invention

Device of the aseptic filling of packages and the method of this filling according to the invention change the usual methods of aseptic filling and sealing of packages by minimizing the aseptic space. The design of the device prevents air from swirling when the package enters the aseptic chamber and exits it, thus preventing contamination of the aseptic chamber by an external non-sterile environment. The essence of the invention is that the package and the closure are sterilized outside the aseptic chamber space before filling and sealing, which ensures that the aseptic chamber is not contaminated during the duty cycle. When filling the product, the filling arm creates one pressure aseptic space with the package, which is also outside the aseptic chamber during filling. This ensures that the aseptic chamber is not contaminated with the filled product during the duty cycle. The essence of the invention consists also in the fact that, in the aseptic chamber of the device, it is possible to close the package at a higher pressure than the product pressure above the filling valve. The advantage of the invention is in the concurrence of several processes at the same time, which significantly shortens the duty cycle. The overpressure of the sterile medium in the aseptic chamber, sterile antechambers, and the power element cabinets ensures aseptic cleanliness of the filling device. The essence of the invention during each duty cycle is to evaluate the tightness of the package, aseptic chamber space, filling space, as well as sterile antechambers and power element cabinets, which prevents contamination of the aseptic chamber by an ambient non-sterile environment or filled product, as well as the possibility of the device to clean and sterilize the components of the filling arm, which have come into contact with the filled product, in the parking position of the filling arm.

### Description of Terms Used to Explain the Essence of the Invention

Aseptic chamber—A sterile space, in which the processes of filling and sealing the product under constant overpressure take place
Closure carrier—Used to move the closure from the sterilization space of the closure into the sealing head, and to separate the aseptic chamber from the outer space
Package carrier—Used to move the package to/from the device and to move the package between the individual positions
Filling arm—Used to fill an empty package with the product
Package—e.g. PET bottle
Closure—e.g. PET closure
Product—Liquid substances, e.g. milk, beer, wine, lemonade, baby food, juice, carbonated and non-carbonated beverages, medicines, but also bulk substances
Sterilization medium—e.g. H₂O₂ vapor
Activation medium—e.g. sterile gaseous N₂
Sterilization—A process, by which all microorganisms in a given environment, object or device are destroyed
Activation—A process, by which the sterilization medium is removed and replaced by the activation medium, creating a protective atmosphere
Package sterilization station—Place of the sterilization medium application
Sealing head—Used to activate the package, close the package, separate the aseptic chamber from the outer space, and connect the aseptic chamber with the activation space of the package
External space—Non-sterile space outside the aseptic chamber
Sterile antechambers—Spaces separating the shafts of the filling arm, sealing head and closure carrier from the external non-sterile environment
Power element cabinets—Spaces separating the power elements of the filling arm, sealing head and closure carrier from the external non-sterile environment
Power elements—e.g. electric motors, servo drives, linear and rotary actuators
Closure cover—Used to create a sterilization space for the closure
Closure sterilization space—Used to apply the sterilization and activation medium to the closure
Sterilization and activation media preparation equipment—Produces an accurate dose of the sterilization and activation medium
Package ring—A part of the package neck used to seal the package in an aseptic chamber
Sterilization medium inlet channel for package—Used to supply the sterilization medium to the package sterilization station
Sterilization medium outlet channel for package—Used to drain the sterilization medium from the package sterilization station
Space of the package sterilization station—A common space above the neck of the package and the inner space of the package, where the sterilization medium is applied
Sterilization medium inlet channel for the closure—Used to supply the sterilization and activation medium to the sterilization space of the closure
Sterilization medium outlet channel for the closure—Used to drain the sterilization and activation medium from the sterilization space of the closure
Package activation space—The space formed by the sealing head and the inner space of the package
Package opening—The point of entry and sealing of the package in the aseptic chamber
Activation medium inlet channel for the package—Used to supply the activation medium to the activation space of the package
Activation medium outlet channel for the package—Used to drain the activation medium from the activation space of the package
Inlet activation channel of the sealing head—Connects the inlet of the activation medium for the package with the activating needle
Outlet activation channel of the sealing head—Connects the space of the package with the outlet channel of the activation medium for the package
Activation needle—A retractable part of the sealing head used to feed in the activation medium
Filling needle—A part of the filling arm used to fill the product into the package
Product feeding channel—Used to supply the filled product to the filling valve
Filling valve—Opens and closes the product inlet to the filling needle
Suction channel—Used to remove product residues from the inner space of the filling needle and the lower part of the filling valve
Filling back-pressure control channel—Used to remove the protective atmosphere medium from the filling space of the package and the product residues from the outer space of the filling needle
Suction valve—Opens and closes the suction channel
Filling valve rod—Opens and closes the filling valve
Filling back—pressure control valve-Sets the flow rate of the extruded medium of protective atmosphere
Filling arm shaft—Used to transmit a rotary and linear motion from the power elements to the filling arm
Sealing head shaft—Used to transmit a rotary and linear motion from the power elements to the sealing head
Closure carrier shaft—Used to transmit a rotary and linear motion from the power elements to the closure carrier
Filling space—A space consisting of the package, filling needle, suction channel and filling pressure control channel
Sealing surface of the package for the closure—A contact surface of the package, on which the sealing surface of the closure rests
Pressure equalization valve—Used to equalize the pressure in the sterilization space of the closure with the pressure in the aseptic chamber
Aseptic chamber pressurization valve—Ensures constant overpressure of the activation medium in the aseptic chamber
Suction shut-off valve—Creates sharp pressure changes during suction by pulsing
Pressure equalization channel—Connects the sterilization space of the closure with the aseptic chamber
Protective atmosphere—The gas that remained in the activation space of the package after activation
Suction—A process that removes the filling arm from the residues of the filled product
Compliant package—A package suitable for filling
Non-compliant package—A package unsuitable for filling

### OVERVIEW OF FIGURES IN THE DRAWINGS

FIG. 1 shows the device as a whole. It is also a picture to the Abstract.

FIG. 2 shows the position for loading and unloading the package; the position for sterilizing the package, and the position for filling and sealing the package when viewed from above the device

FIG. 3 shows the sealing head in its basic position.

FIG. 4 shows the filling arm in its filling position.

FIG. 5 shows the closure carrier in its transfer position.

FIG. 6 shows the space of the package sterilization station.

FIG. 7 shows the device in the process of sucking in the product residues after filling.

FIG. 8 shows the device in the process of filling the product.

FIG. 9 shows the filling space.

FIG. 10 shows the device in the process of activating the package.

FIG. 11 shows the device in the process of sealing a filled package.

FIG. 12 shows the activation space of the package.

FIG. 13 shows the sterilization space of the closure.

FIG. 14 shows the device in the process of sterilizing and activating the closure.

FIG. 15 shows the device in the process of equalizing the pressure of the aseptic chamber with the sterilization space of the closure.

### EXAMPLE OF AN EMBODIMENT OF THE INVENTION

It is to be understood that the embodiment of the device according to the invention is presented by way of illustration and should not be construed as limiting its technical solutions. Those skilled in the art will be able to ascertain many equivalents to specific embodiments of the invention using no more than routine experimentation. Such equivalents of the manufactured device and its parts will also fall within the scope of the patent claims. It cannot be problematic for those skilled in the art to optimally design the structure and select its elements, so these features have not been addressed in detail in this description.

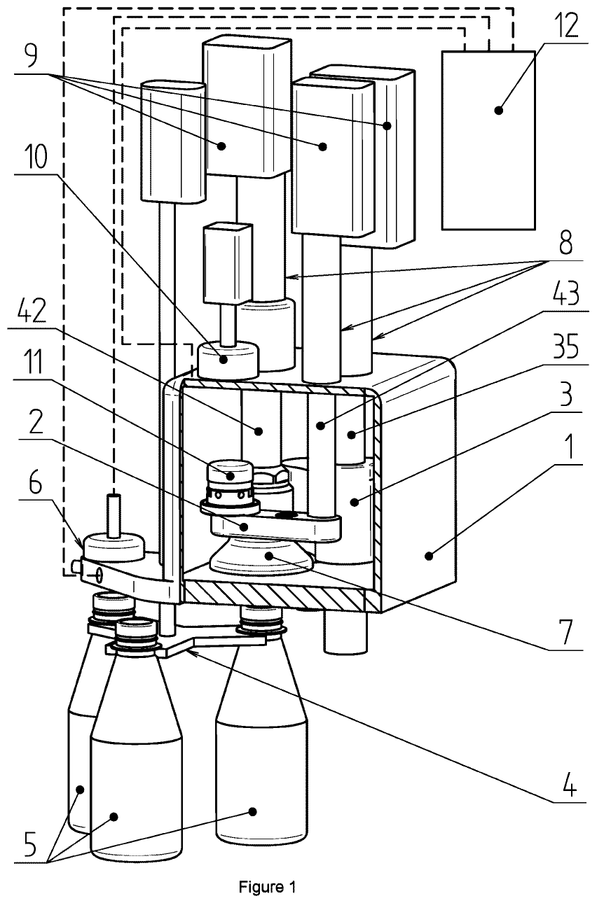

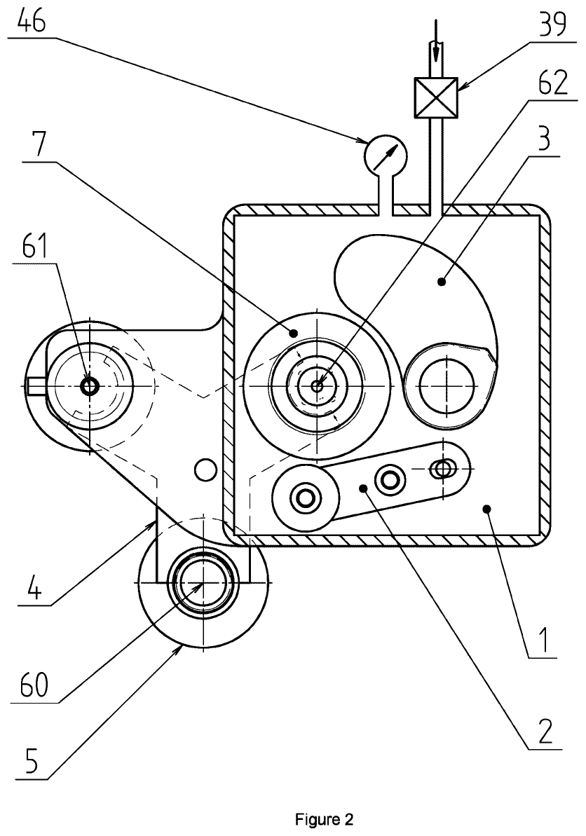

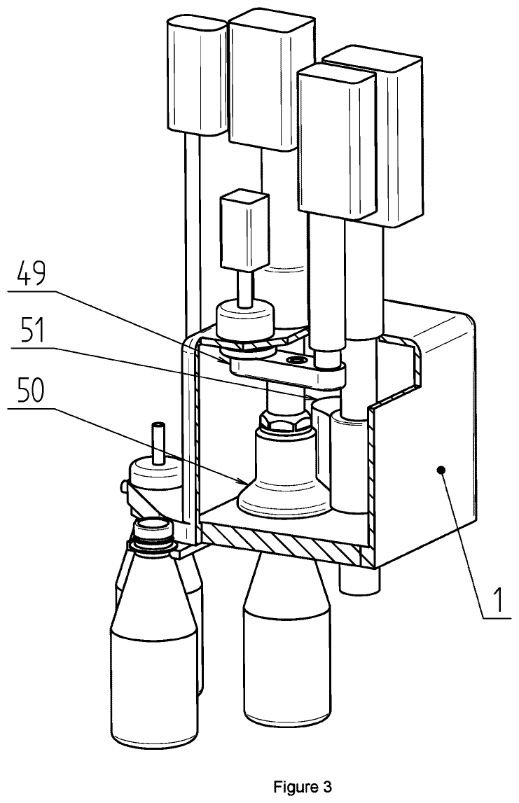

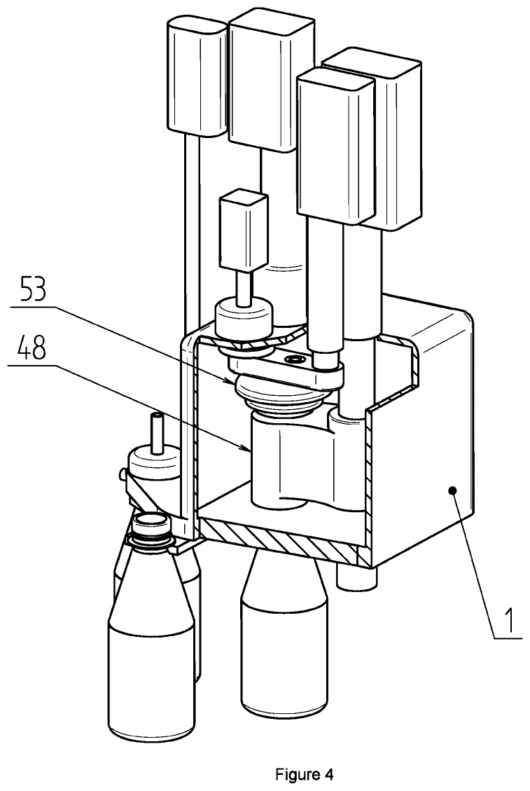

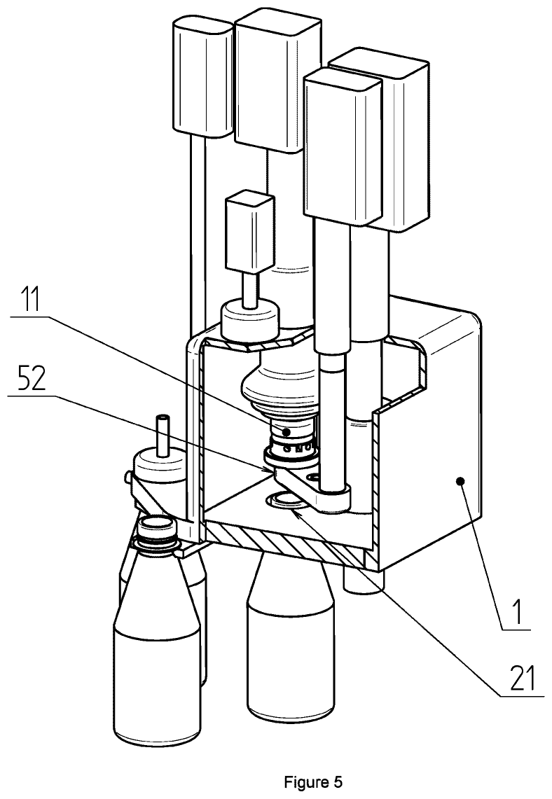

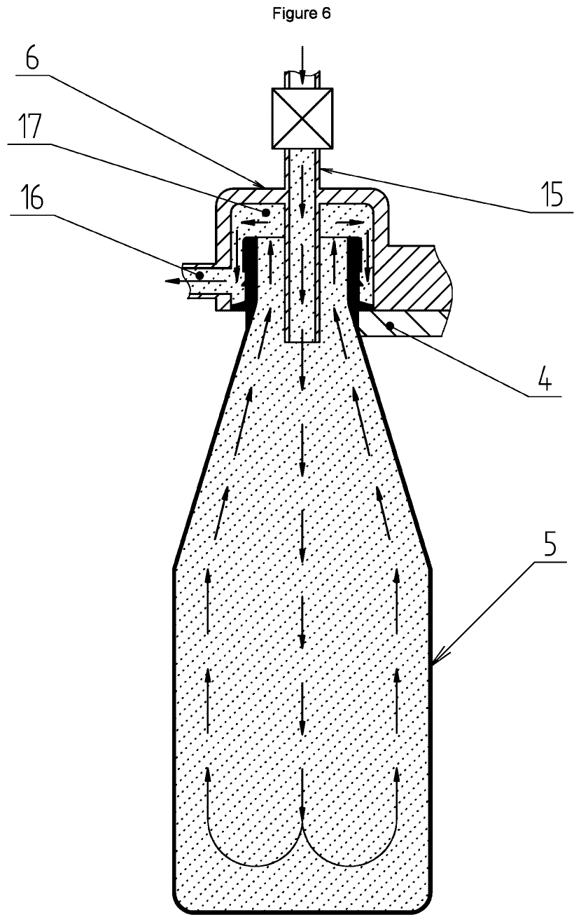

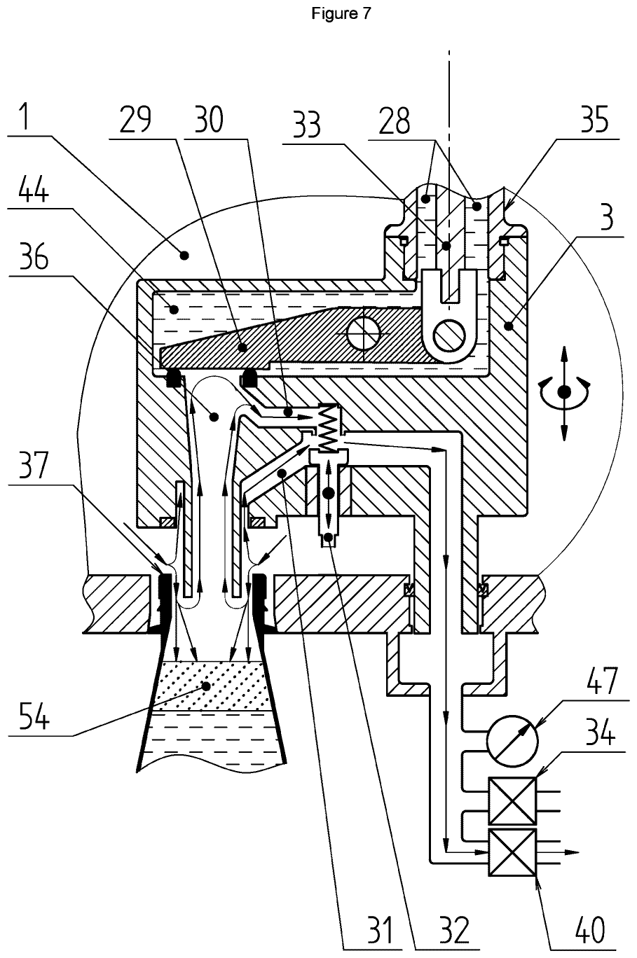

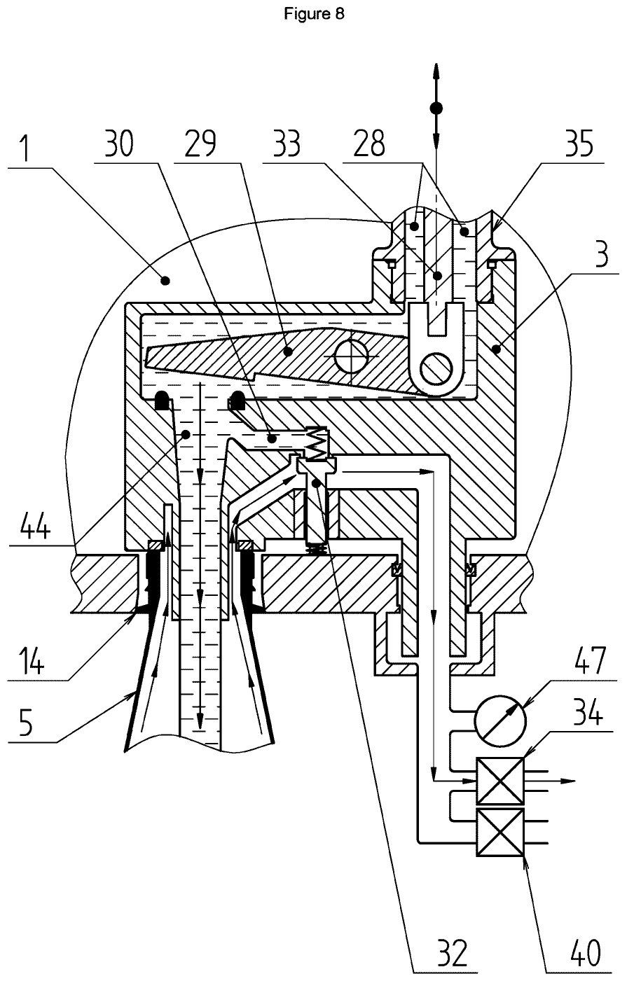

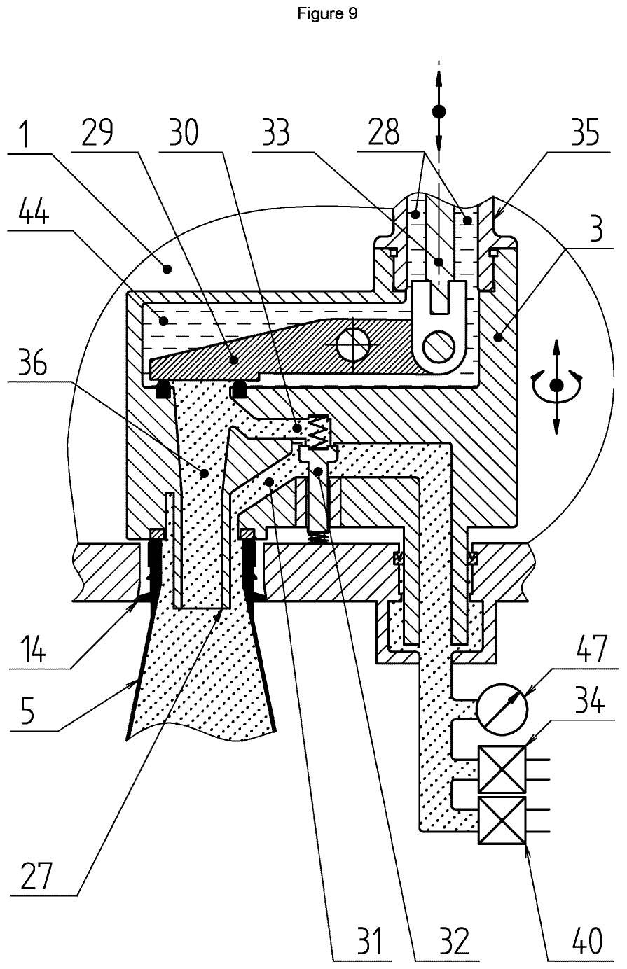

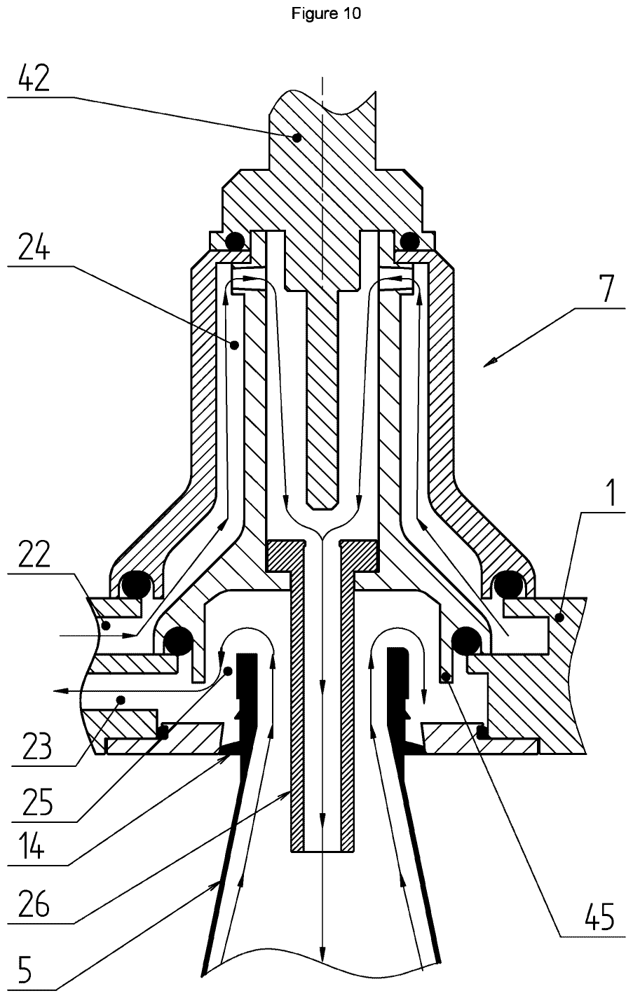

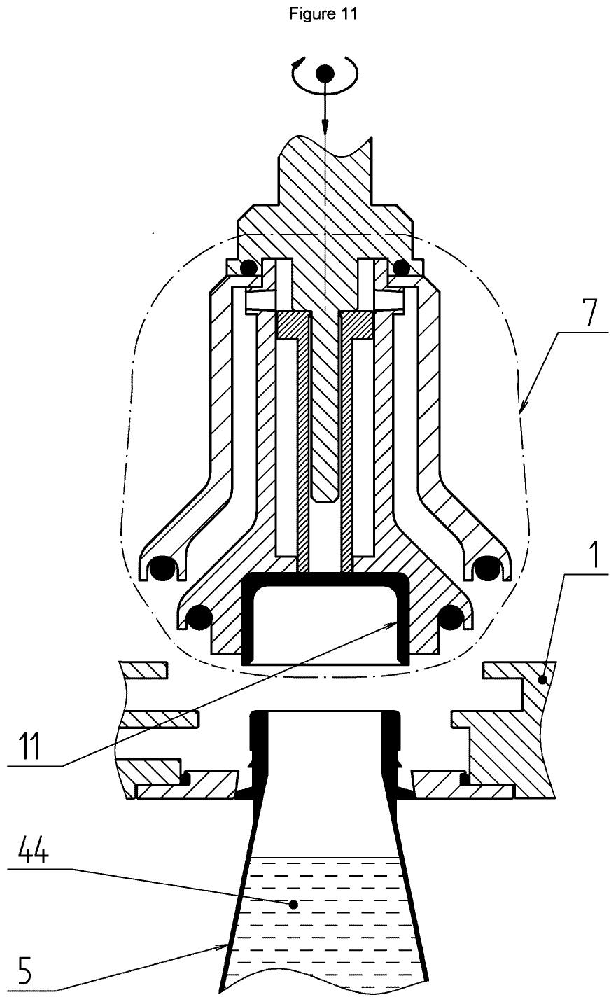

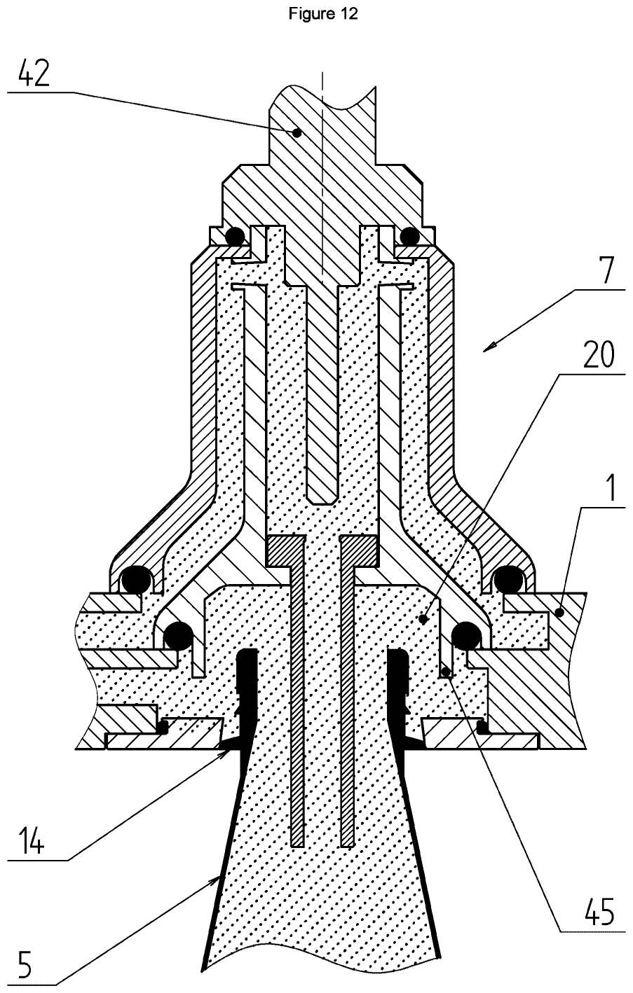

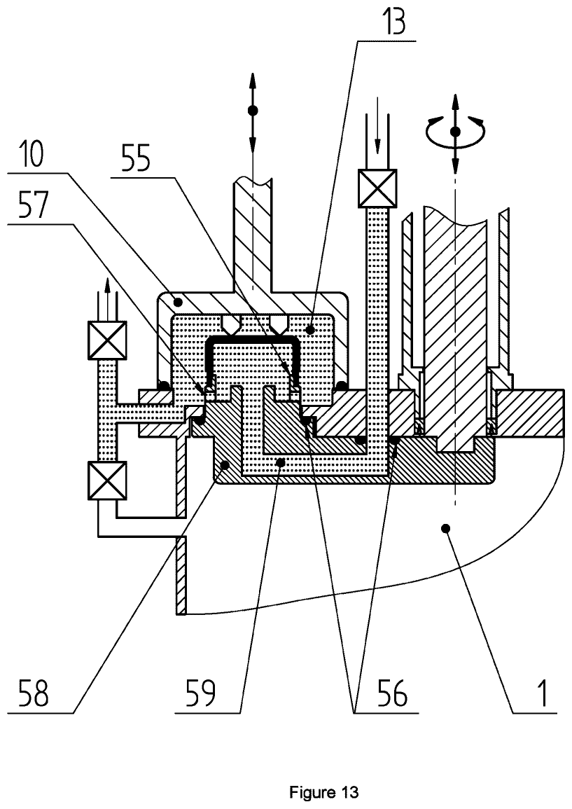

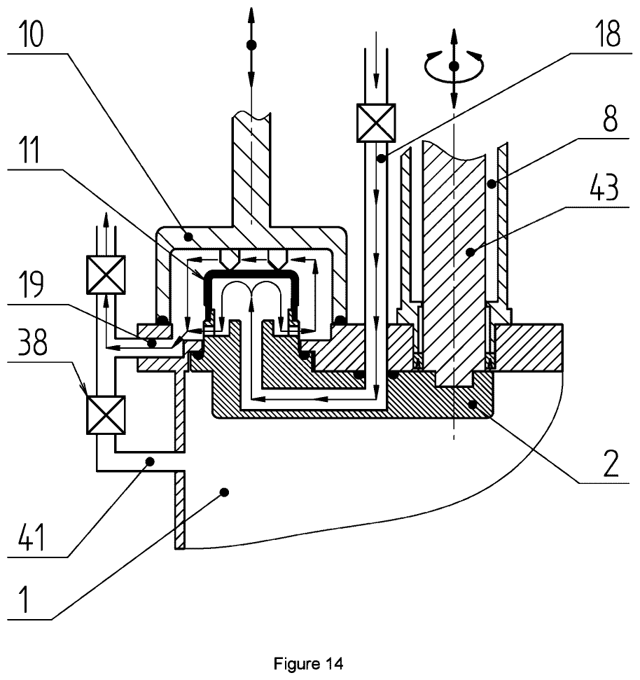

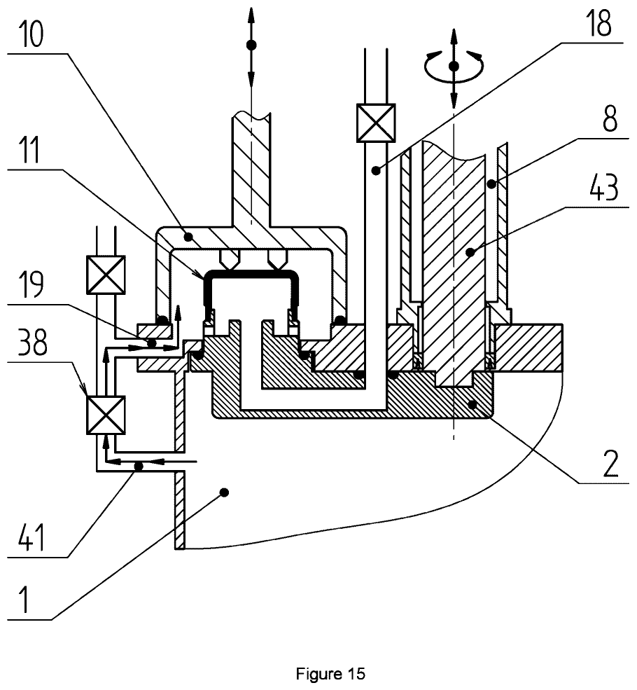

According to the invention, the device for the aseptic filling of packages shown in FIGS. 1 to 15 consists of a base part, which is formed by an aseptic chamber 1, inside which parts of the device are movably mounted, i.e. the filling arm 3, the sealing head 7, and the closure carrier 2.

The other components of the device are connected to the aseptic chamber 1, which are the package carrier 4, the package sterilization station 6, sterile antechambers 8, power element cabinets 9, and the closure cover 10.

The device also consists of a system of pipes for the supply and discharge of individual media, and of the power/security/control elements.

The movement of the filling arm 3, sealing head 7 and closure carrier 2 is ensured by the power elements housed in the sterile power element cabinets 9 by means of shafts of individual components, i.e. the filling arm shaft 35, the sealing head shaft 42, and the closure carrier shaft 43, which enter the space of the aseptic chamber 1, the sterility of these shafts being ensured by sterile antechambers 8, in which these shafts are stored. Sterile antechambers 8 and the power element cabinets 9 are equipped with the inlet and outlet channels, which ensure the application of the sterilization medium and its subsequent activation in these spaces.

In this example of a specific embodiment of the invention, the package carrier 4 is designed as a three-arm carrier with three positions for the package 5. The package carrier 4 can also be multi-positional and can be of a different shape.

The aseptic chamber 1, the sterile antechambers 8 and the power element cabinets 9 are pressure independent of each other; the pressure in the aseptic chamber 1 is higher than the pressure in the sterile antechambers 8, and this being higher than the pressure in the power element cabinets 9. The pressure in the power element cabinets 9 must be higher than the atmospheric pressure of the environment, in which the device in question is installed. During initialization, the aseptic chamber 1, the sterile antechambers 8 and the power element cabinets 9 are sterilized. During the duty cycle, the sterile antechambers 8 and the power element cabinets 9 are flushed with the activation medium without the sterilization medium being applied, and the aseptic chamber 1 is pressurized with the activation medium without flushing. This ensures multi-stage protection of the sterility of the aseptic chamber 1 and the shafts that enter it.

The preparation of the duty cycle of the device begins with the initialization of the device, which consists in sterilizing all spaces and pipes of the device with a risk of contamination during filling and sealing the package 5, in closing the aseptic chamber 1 by setting the closure carrier 2 to its basic position 49, and the sealing head 7 into its basic position 50, by setting the filling arm 3 to its parking position 51, and in filling the aseptic chamber 1 with the activation medium to a higher pressure than the product pressure 44 above the filling valve 29. The aseptic chamber pressurization valve 39 is now open, thus ensuring the supply of the sterile activation medium and maintaining a constant overpressure in the aseptic chamber 1. The aseptic chamber 1 is equipped with an aseptic chamber pressure gauge 46, which monitors the pressure of the activation medium in the aseptic chamber 1 and, if it falls below the desired value, the device evaluates the condition in the aseptic chamber 1 as leaking and requests re-initialization of the device.

An empty package 5 is inserted in position A 60 into the package carrier 4. The package carrier 4 performs a vertical downward movement with the empty package 5; it moves the empty package 5 from position A 60 to position B 61 below the package sterilization station 6 by a rotary movement, and then by a subsequent vertical movement upwards closes the space of the package sterilization station 17 by means of a package ring 14. After this movement, an empty package 5 is inserted into the empty carrier 4 to the empty position A 60, and is waiting to be moved to the position B 61.

A pre-prepared dose of the sterilization medium from the sterilization and activation medium preparation device 12 is applied in the sterilization station of the package 6 via the sterilization medium inlet channel for the package 15, to the inner walls of the package 5, to the outer part of the neck of the package 5 through to the package ring 14, including the sterilization medium outlet channel for the package 16.

A closure 11 is inserted into the closure carrier 2 which, once inserted, is closed by the closure cover 10, thereby creating a sterilization space of the closure 13.

In the formed sterilization space of the closure 13, a pre-prepared dose of the sterilization medium from the sterilization and activation medium preparation device 12 is applied to all surfaces of the sterilization space of the closure 13 and to all surfaces of the closure 11, including the sterilization medium outlet channel for the closure 19, through the sterilization medium outlet channel 18.

After the necessary sterilization medium exposure time, a pre-prepared dose of the activation medium from the sterilization and activation medium preparation device 12 is applied to all areas of the sterilization space of the closure 13 and to all areas of the closure 11 via the sterilization medium inlet channel for the closure 18, which is discharged through the sterilization medium outlet channel for the closure 19 outside the sterilization space of the closure 13.

The device according to the invention is now ready to start the duty cycle.

The work cycle begins with the package carrier 4 performing a vertical downward movement with the package 5 in position B 61, in which the dose of the sterilization medium is applied and, at the same time, with the empty package 5 in position A 60; with the rotary move, it moves the package 5 from position B 61 to position C 62 below the package opening 21 and, at the same time, the empty package 5 from position A 60 to position B 61 and, with the subsequent vertical movement with the packages 5 upwards, it closes the activation space of the package 20 and the space of the package sterilization station 17 by means of package rings 14. With this movement, the arm of the package carrier 4 is set from position C 62 to position A60, into which the empty package 5 is inserted, waiting to be moved to position B 61.

The activation medium is applied to the package 5 via the activation medium inlet channel for the package 22 and the inlet activation channel of the sealing head 24 through the actuating needle 26, which is pushed inwards by the pressure of the activation medium into the package 5, thereby expelling the sterilization medium from the package 5—the sterilization medium is activated. Extension of the actuating needle 26 ensures a better flow of the activation medium in the space of the package 5. The sterilization medium is discharged from the package 5 around the outer wall of the package 5 neck via the outlet activation channel of the sealing head 25 and the activation medium outlet channel for the package 23 outside the activation space of the package 20. By expelling out the sterilization medium, the activation space of the package 20 is sterilized. The activation of the package is completed by setting the desired pressure of the activation space of the package 20, which is equal to the pressure in the aseptic chamber 1.

The sealing head 7 is moved from its basic position 50 by a vertical upward movement to the parking position 53, thus allowing the movement of the filling arm 3 and the closure carrier 2 in the aseptic chamber 1. By this movement of the sealing head 7, the package 5 becomes part of the aseptic chamber 1. The pressurization valve of the aseptic chamber 39 is closed and the pressure in the aseptic chamber 1 is monitored by the pressure gauge of the aseptic chamber 46.

If the pressure in the aseptic chamber 1 does not drop during monitoring, the device evaluates the package 5 as suitable for the duty cycle to continue. This above-described monitoring of the pressure drop in the aseptic chamber 1 is referred to as the primary package tightness test, but also the tightness test of the aseptic chamber 1. At the end of the package 5 tightness test, the pressurization valve of the aseptic chamber 39 is re-opened. If the package 5 was evaluated to be compliant, the device continues in the duty cycle.

The filling arm 3 opens the suction valve 32 by a vertical upward movement, thus clearing the suction channel 30 up to the suction shut-off valve 40; and a subsequent rotary movement moves the filling arm 3 over the package 5. During this movement, the residues of the sterilization medium, which may have become trapped on the filling needle 27 during the sterilization of the aseptic chamber 1, or the residues of the product 44, which may have become trapped on the filling needle 27 during its filling, take place simultaneously. Suction is achieved by a sharp pressure change during the pulse opening and closing of the suction shut-off valve 40 via the suction channel 30 and the filling back-pressure control channel 31. At the end of the suction, the suction shut-off valve 40 closes.

The filling arm 3 makes a vertical movement downwards to rest on the neck of the package 5, whereby it is sealed and a filling space 36 is formed. At the same time, the space of the package 5 is separated by the filling arm 3 from the space of the aseptic chamber 1. By moving the filling arm 3 vertically downwards, the suction valve 32 closes.

The filling back-pressure control valve 34 opens; when the pressure in the filling space 36 drops to the desired value monitored by the pressure gauge of the package 47, the filling back-pressure control valve 34 closes and the package 5 is evaluated as compliant.

This above-described monitoring of the pressure drop in the filling space 36 is referred to as the secondary package tightness test, but also the filling space 36 tightness test.

If there is no pressure drop in the filling space 36 during the secondary package 5 tightness test, the filling back-pressure control valve 34 closes and the device evaluates the package 5 as non-compliant. The filling arm 3 is moved to its parking position 51 by performing a vertical upward movement, a rotary movement, and a subsequent vertical downward movement. The duty cycle continues in the non-compliant package cycle as described below.

If the package 5 was evaluated in this secondary tightness test as compliant, the device continues the duty cycle; by opening the filling valve 29, the filling process begins; as the product 44 flows into the package 5, the volume of the protective atmosphere medium is expelled through the filling back-pressure control channel 31 through the filling back-pressure control valve 34 outside the filling area 36. The filling back-pressure control valve 34 adjusts the flow rate of the extruded protective atmosphere medium, thereby controlling the filling rate of the product 44 into the package 5. After the product 44 reached the required filling volume, the filling valve 29 closes. The filling arm 3 is lifted by a vertical upward movement above the package 5, thus connecting the package space 5 with the aseptic space of the chamber 1. The pressure in the aseptic chamber 1, which is higher than the pressure of the filled product 44 in the package 5, equalizes due to the connection of the package 5 to the space of the aseptic chamber 1, which causes the foam of the product 54 to be compressed downwards and thus stabilizing it so that the product 44 does not come into contact with the thread of the package 5 and at the same time the action of higher pressure in the aseptic chamber removes any product residues 44 from the sealing surface of the package for the closure 37 into the package 5.

By a vertical move of the filling arm 3 upwards, the suction valve 32, which clears the suction channel 30, is simultaneously opened. Through the suction channel 30 and the filling back-pressure control channel 31, the residues of the filled product 44, which may have become trapped on the filling needle 27 during filling, are sucked out. Suction is achieved by a sharp pressure change during the pulse opening and sealing of the suction shut-off valve 40 via the suction channel 30 and the filling back-pressure control channel 31. At the end of the suction, the suction shut-off valve 40 closes. By means of a rotary and subsequent vertical downward movement, the filling arm 3 is moved to the parking position 51.

During the filling process, the process of inserting the closure 11 into the sealing head 7 also takes place, beginning with opening the pressure equalization valve 38, whereby the pressure in the sterilization space of the closure 13 equalizes with the pressure in the aseptic chamber 1 through the pressure equalization channel 41. The closure carrier 2 moves the closure 11 under the sealing head 7 by a vertical downward movement and a rotary movement.

The sealing head 7 pushes the closure 11 into the crown of the sealing head 45 by a vertical downward movement and, after a subsequent vertical upward movement, returns to its parking position 53 together with the closure 11. The closure carrier 2 reaches its basic position 49 by a rotary and vertical upward movement, thus allowing the sealing head 7 to move together with the closure 11 towards the package 5. In its basic position 49, the closure carrier 2 separates the space of the aseptic chamber 1 from the sterilization space of the closure 13 and, after the cover of the closure 10 lifts, also from the outer non-sterile space. The closure cover 10 allows a new closure 11 to be inserted into the closure carrier 2 by a vertical upward movement.

A closure 11 is inserted into the closure carrier 2 which, once inserted, closed by the closure cover 10, thereby creating sterilization space of the closure 13. In the formed sterilization space of the closure 13, a pre-prepared dose of the sterilization medium from the sterilization and activation medium preparation device 12 is applied to all surfaces of the sterilization space of the closure 13 and to all surfaces of the closure 11, including the sterilization medium outlet channel for the closure 19, through the sterilization medium outlet channel 18.

After the necessary sterilization medium exposure time, a pre-prepared dose of the activation medium from the sterilization and activation medium preparation device 12 is applied to all areas of the sterilization space of the closure 13 and to all areas of the closure 11 via the sterilization medium inlet channel for the closure 18, which is discharged through the sterilization medium outlet channel for the closure 19 outside the sterilization space of the closure 13.

During the process of inserting and sterilizing the closure 11, the process of sealing the package 5 begins.

The sealing head 7 seals up the package 5 with the closure 11 with the downward movement. After the filled package 5 was sealed, the sealing head 7 closes the aseptic chamber 1. The package carrier 4 pulls the sealed package 5 out of the sealing head 7 by a vertical downward movement and transfers it from position C 62 to position A 60 by a rotary movement; the subsequent vertical upward movement completes the whole process of filling and sealing the package 5. After this process, the filled and sealed package 5 is exchanged for an empty package 5 and a new duty cycle is started.

If the package 5 was evaluated as non-compliant in the primary or secondary package 5 tightness test, the duty cycle continues in the duty cycle for the non-compliant package.

By opening the pressure equalization valve 38, the pressure in the sterilization space of the closure 13 is equalized through the pressure equalization channel 41 with the pressure in the space of the aseptic chamber 1. The closure carrier 2 moves the closure 11 under the sealing head 7 by a vertical downward movement and a rotational movement.

The sealing head 7 pushes the closure 11 into the crown of the sealing head 45 by a vertical downward movement and, after a subsequent vertical upward movement, returns to the parking position 53 together with the closure 11. The closure carrier 2 reaches its basic position 49 by the rotation and vertical upward movement, thus separating the aseptic chamber 1 from the sterilization space of the closure 13, and allowing the sealing head 7 to move together with the closure 11 towards the package 5. In its basic position 49, the closure carrier 2 separates the space of the aseptic chamber 1 from the sterilization space of the closure 13 and, after the cover of the closure 10 lifts, also from the outer non-sterile space. The closure cover 10 allows a new closure 11 to be inserted into the closure carrier 2 by a vertical upward movement.

A new closure 11 is inserted into the closure carrier 2 which, once being inserted, is closed by the closure cover 10, thereby creating a sterilization space of the closure 13. In the formed sterilization space of the closure 13, a pre-prepared dose of the sterilization medium from the sterilization and activation medium preparation device 12 is applied to all surfaces of the sterilization space of the closure 13 and to all surfaces of the closure 11, including the sterilization medium outlet channel for the closure 19, through the sterilization medium outlet channel 18.

After the necessary sterilization medium exposure time, a pre-prepared dose of the activation medium from the sterilization and activation medium preparation device 12 is applied to all areas of the sterilization space of the closure 13 and to all areas of the closure 11 via the sterilization medium inlet channel for the closure 18, which is discharged through the sterilization medium outlet channel for the closure 19 outside the sterilization space of the closure 13. During the process of inserting and sterilizing the closure 11, the process of sealing the package 5 begins.

The sealing head 7 seals up the package 5 with the closure 11 with the downward movement. After the package 5 was sealed, the sealing head 7 closes the aseptic chamber 1. The package carrier 4 pulls the sealed package 5 out of the sealing head 7 by a vertical downward movement and transfers it from position C 62 to position A 60 by a rotary movement; the subsequent vertical upward movement completes the process of scaling the non-compliant package. After this process, the unfilled sealed package 5 is exchanged for an empty package 5 and a new duty cycle is started.

### Legend to the Attached Drawings—FIGS. 1 to 15

1) Aseptic chamber
2) Closure carrier
3) Filling arm
4) Package carrier
5) Package
6) Package sterilization station
7) Sealing head
8) Sterile antechambers
9) Power element cabinets
10) Closure cover
11) Closure
12) Equipment for the preparation of the sterilization and activation media
13) Closure sterilization space
14) Package ring
15) Sterilization medium inlet channel for package
16) Sterilization medium outlet channel for package
17) Package sterilization station space
18) Sterilization medium inlet channel for closure
19) Sterilization medium outlet channel for closure
20) Activation space of the package
21) Package opening
22) Activation medium inlet channel for the package
23) Activation medium outlet channel for the package
24) Sealing head inlet activation channel
25) Sealing head outlet activation channel
26) Activation needle
27) Filling needle
28) Product feeding channel
29) Filling valve
30) Suction channel
31) Filling back-pressure control channel
32) Suction valve
33) Filling valve rod
34) Filling back-pressure control valve
35) Filling arm shaft
36) Filling space
37) Sealing surface of the package for the closure
38) Pressure relief valve
39) Aseptic chamber pressurization valve
40) Suction shut-off valve
41) Pressure equalization channel
42) Sealing head shaft
43) Closure carrier shaft
44) Product
45) Sealing head crown
46) Aseptic chamber pressure gauge
47) Package pressure gauge
48) Position of the filling arm during filling
49) Basic position of the closure carrier
50) Basic position of the sealing head
51) Position of the filling arm during filling
52) Transfer position of the closure carrier
53) Parking position of the sealing head
54) Product foam
55) Closure seat
56) Sealing surfaces of the closure carrier
57) Closure carrier outlet channels
58) Closure carrier arm
59) Closure carrier application channel
60) Position A-Position for loading and unloading package
61) Position B-Position for sterilization of the package
62) Position C-Position for activating, filling and sealing the package

### INDUSTRIAL APPLICABILITY

The device and method of aseptic filling of packages according to the invention finds its application especially in the food and pharmaceutical industries.

1. A device for aseptic filling of packages, comprising: an aseptic chamber (1), a filling arm (3), a sealing head (7), a closure carrier (2), a package carrier (4), a package sterilization station (6), a sterile antechambers (8), power element cabinets (9), power elements housed therein, a closure cover (10), a filling arm shaft (35), a sealing head shaft (42), and a closure carrier shaft (43).

2. The device for aseptic filling of packages of claim 1, wherein the aseptic chamber (1), together with the sealing head (7) and the closure carrier (2) are located in positions, that form one common sterile pressure-sealed space.

3. The device for aseptic filling of packages of claim 1, wherein the filling arm (3) comprises a filling needle (27), a product feeding channel (28), a filling valve (29), a suction valve (32), a suction channel (30), a filling back pressure control channel (31), and a filling valve rod (33), all of which are sterile during the duty cycle.

4. The device for aseptic filling of packages of claim 1, wherein the sealing head (7) comprises an activating needle (26), an inlet activating channel of the sealing head (24), a outlet activating channel of the sealing head (25), and a crown of a sealing head (45).

5. The device for aseptic filling of packages of claim 1, wherein the closure carrier (2) comprises a closure carrier arm (58), closure carrier sealing surfaces (56), a closure carrier application channel (59), closure carrier outlet channels (57), and a closure seat (55).

6. The device for aseptic filling of packages of claim 2, wherein the package sterilization station (6) is located outside the common sterile pressure-sealed space.

7. The device for aseptic filling of packages of claim 1, further including a position A (60) for loading/unloading the packages, position B (61) for sterilizing the packages, and position C (62) for activating, filling and sealing the packages, while the processes at the individual positions take place simultaneously and independently of each other.

8. A method of aseptic filling of packages, comprising:
inserting an empty package (5) into a package carrier (4);
transferring the package to a sterilization station (6), and applying a dose of sterilization medium to the package (5);
transferring the package (5) to a package activation space (20) and activating the package by using the sealing head (7) and by setting the required pressure in the package (5);
connecting the package (5) with a space of the aseptic chamber (1) by moving the sealing head (7) to a parking position (53);
performing a suction process while a filling arm (3) over the package (5);
evaluating the tightness of the package (5) in the filling space (36) when the filling arm (3) rests on a neck of the package (5), and filling the package (5) with a product (44);
lifting the filling arm (3) to removes product residues (44) caused by a change in pressure, and compressing a product foam (54);
performing again the suction process when moving the filling arm (3) away from the package (5);
simultaneously with the above steps, sterilizing and activating a closure (11) in a sterilization space of the closure (13);
moving the closure (11) from a closure carrier (2) to the package (5) by using the sealing head (7), and sealing the package (5) by using the rotary and vertical movement of the sealing head (7);
closing the aseptic chamber (11) by using the sealing head (7).

9. The method of aseptic filling of packages of claim 1, wherein the empty package (5) inserted into the package carrier (4) is transferred to the package sterilization station (6), where a dose of sterilization medium is applied; then, the package (5) is transferred to the package activation space (20); the activation medium is applied to the package (5) via the activation medium inlet channel (22) and the inlet activation channel of the sealing head (24) through the actuating needle (26), which is pushed towards the inside of the package (5) by pressure of the activation medium, thereby expelling the sterilization medium from the package (5), which is discharged from the package (5) around the outer wall of the package neck (5) through the outlet activation channel of the sealing head (25) and the activation medium outlet channel for the package (23) outside the activation space of the package (20) and outside the aseptic chamber space (1), whereby the entire volume of the package is filled with the activation medium and the required pressure of the activation space of the package (20) is set as equal to the pressure in the aseptic chamber (1), and the actuation space of the package (20) is sterilized, which becomes part of the aseptic chamber (1) by the movement of the sealing head (7).

10. The method of aseptic filling of packages of claim 1, wherein the activation of the package (5) is made by a gaseous activation medium, which, at the same time, serves as a protective atmosphere for the filled product (44).

11. The method of aseptic filling of packages of claim 1, wherein by the pulse opening and closing of the suction shut-off valve (40) with the open suction valve (32), the sterilization medium residues that may have become trapped on the filling needle (27) during the sterilization of the aseptic chamber (1), or product residues (44) that may have become trapped on the filling needle (27) when it was filled, are extracted by a rapid pressure change through the suction channel (30) and the filling back-pressure control channel (31).

12. The method of aseptic filling of packages of claim 1, wherein the placing of the filling arm (3) on the neck of the package (5) seals up the package (5) and makes a filling space (36) separated from the aseptic chamber space (1); at the same time, the suction valve (32) closes, which allows the protective atmosphere medium to be discharged from the package (5); then, the monitoring of the pressure with the package pressure gauge (47) in the filling space (36) and with pressure gauge in the aseptic chamber (46), when the aseptic chamber pressurization valve is closed (39), evaluates the tightness of the package (5) and the aseptic chamber (1); the opening of the filling valve (29) initiates the filling process and, after the required filling volume of the product (44) is achieved, the filling valve (29) closes.

13. The method of aseptic filling of packages of claim 1, wherein the lifting of the filling arm (3) over the package (5), connecting the space of the package (5) with lower pressure with the aseptic space of the chamber (1) with higher pressure, ensures that any product residues (44) are removed from the sealing surface of the closure package (37) into the package (5), and the product foam (54) is compressed.

14. The method of aseptic filling of packages of claim 1, wherein a closure (11) is inserted into the closure carrier (2) which, after insertion, is closed by a closure cover (10), thereby creating a sterilization space of the closure (13), in which sterilization and activation of the closure take place (11), and the sterilization space of the closure (13); then, after the pressure is equalized in the aseptic chamber (1) by the sealing head (7), the closure (11) is taken over from the closure carrier (2), transferred over the package (5) and the package (5) is closed by moving the sealing head (7) downwards.

15. The method of aseptic filling of packages of claim 1, wherein the aseptic chamber (1), the filling arm (3), the power element cabinets (9) and the power elements stored therein, sterile antechambers (8), the filling arm shaft (35), the sealing head shaft (42), and the closure carrier shaft (43) are sterilized at initialization and maintained in constant sterility by overpressure until the end of the last duty cycle.

16. The method of aseptic filling of packages of claim 1, wherein the package (5) and the closure (11) are sterilized by application of the sterilization medium and subsequent application of the activation medium outside the aseptic chamber (1) while, by moving the sealing head (7) vertically to its parking position (53) and by moving the closure carrier (2) vertically downwards, they become part of the sterile space of the aseptic chamber (1).

17. The method of aseptic filling of packages of claim 1, wherein only the sterile elements, packages (5) and closures (11) enter the space of the aseptic chamber (1).

18. The method of aseptic filling of packages of claim 1, wherein by monitoring the pressure changes in the package (5) and in the aseptic chamber (1), the device evaluates the tightness of the package (5), the package ring (14), the sealing surface for the closure (37) and the aseptic chamber (1) according to the invention.

19. The method of aseptic filling of packages of claim 1, wherein the filling arm (3) separates the aseptic chamber (1) from the filling space (36) in its filling position (48), and the filling takes place in the filling space (36) outside the aseptic chamber (1).

20. The method of aseptic filling of packages of claim 1, wherein the rate of filling of the product (44) into the package (5) is controlled by the flow rate of the activation medium extruded through the filling back-pressure control valve (34).

21. The method of aseptic filling of packages of claim 1, wherein the sealing head (7) closes the aseptic chamber (1) after the filled package (5) is sealed.

22. The method of aseptic filling of packages of claim 1, wherein the sealing head (7) performs the function of activation of the package (5), the function of sealing the package (5) by the closure (11), and the function of sealing the aseptic chamber (1).

23. The method of aseptic filling of packages of claim 1, wherein the closure carrier (2) and the closure cover (10) form a common sterilization space of the closure (13), in which the sterilization medium is applied to the closure (11), which is held in this space by a minimum contact surface of the closure cover (10) and the closure seat (55) to ensure an even application of the sterilization and activation medium onto the closure (11).
